(19) United States
(12) Patent Application Publication
(10) Pub. No.: US 2026/0099642 A1
(43) Pub. Date: Apr. 9, 2026

(54) METHOD FOR IN-SITU DETERMINATION OF TIME-VARYING PERFORMANCE PARAMETERS OF 3D-PRINTED CONCRETE MATERIALS

(71) Applicant: Tongji University, Shanghai (CN)

(72) Inventors: Jiaolong ZHANG, Shanghai (CN); Jinyuan ZHANG, Shanghai (CN); Yong YUAN, Shanghai (CN); Xupeng YAO, Shanghai (CN)

(21) Appl. No.: 19/190,724

(22) Filed: Apr. 27, 2025

(30) Foreign Application Priority Data
Oct. 6, 2024 (CN) 202411387652.5

(51) Int. Cl. G06F 30/20; G06F 113/10; G06F 119/12

(52) U.S. Cl. CPC G06F 30/20; G06F 2113/10; G06F 2119/12

(57) ABSTRACT

The present disclosure relates to the technical field of civil engineering and construction. It provides a method for in-situ determination of time-varying performance parameters of 3D-printed concrete materials, including: S100: determining the to-be-tested parameters based on a time-varying constitutive model constructed using a physics-informed neural network (PINN), proceeding to S200; S200: determining, based on the time-varying constitutive model and initial parameters, structural deformation results; S300: acquiring real-time 3D geometric data of concrete structures during a 3D printing process, generating and transmitting the real-time 3D point cloud data to obtain actual measured deformation data; S400: optimizing, through inversion analysis based on comparison between structural deformation results computed in S200 and actual measured deformation data from S300, time-varying performance parameters; storing the time-varying performance parameters by inversion analysis and iteratively proposing and refining a new time-varying constitutive model using a data-driven approach.

### CROSS REFERENCE TO RELATED APPLICATIONS

The present disclosure claims the priority of Chinese Patent Application No. 202411387652.5 filed on Oct. 6, 2024. All the above are hereby incorporated by reference in their entirety.

### TECHNICAL FIELD

The present disclosure relates to the technical field of civil engineering and construction, and more particularly to a method for in-situ determination of time-varying performance parameters of 3D-printed concrete materials.

### BACKGROUND

With the continuous advancement of civil engineering technology, additive manufacturing technology (i.e., 3D printing technology) has achieved significant progress in research and development within the civil engineering and construction field, particularly in the application of concrete materials. 3D-printed concrete technology achieves rapid construction of complex geometric structures through layer-by-layer material accumulation, demonstrating significant potential in reducing construction time, costs, and material consumption. However, due to the rapid setting of 3D-printed concrete materials resulting from additive effects within extremely short time frames, which exhibits significant time-varying properties, and further complicated by complex environmental conditions, the accurate prediction and characterization of their mechanical properties remains a substantial challenge.

The constitutive model of 3D-printed concrete serves as a fundamental tool for describing its mechanical behavior. The continuity and time-varying properties of the material make it imperative to acquire and update these model parameters in real time during the printing process. However, existing technologies primarily rely on material testing under laboratory conditions, which typically require extended testing periods. During such prolonged testing durations, the properties of 3D-printed concrete undergo significant changes, thereby making it challenging to capture the time-varying parameters that characterize the material's performance evolution accurately.

### SUMMARY

In view of the aforementioned deficiencies of the prior art, proposed in the present disclosure is a method for in-situ determination of time-varying performance parameters of 3D-printed concrete materials. The technical solution includes the following steps:
S100: determining, based on a time-varying constitutive model constructed by a physics-informed neural network (PINN), the to-be-tested parameters, in which the to-be-tested parameters are configured to describe critical mechanical properties of the concrete materials during a time-varying process, proceeding to S200;
S200: determining, based on the time-varying constitutive model and initial parameters, structural deformation results;
S300: acquiring, by employing a binocular vision monitoring system based on stereo matching and disparity calculation, real-time 3D geometric data of concrete structures during a 3D printing process, generating and transmitting the real-time 3D point cloud data to obtain actual measured deformation data;
S400: optimizing, through inversion analysis based on comparison between structural deformation results computed in S200 and actual measured deformation data from S300, time-varying performance parameters, and storing the time-varying performance parameters by inversion analysis, and iteratively proposing and refining a new time-varying constitutive model using a data-driven approach.

In some implementations, in S100, the to-be-tested parameters comprise but are not limited to the elastic modulus, viscosity coefficient, and strength parameter.

In some implementations, in S200, calculating, based on the predefined constitutive model and the initial parameters, corresponding structural deformation patterns for the inversion analysis.

In some implementations, in S300, generating, by employing 3D geometric data acquired from the binocular vision monitoring system based on stereo matching and disparity calculation, high-precision real-time 3D point cloud data, enabling a real-time update of material deformation information during the printing process.

In some implementations, in S300, the generating and transmitting real-time 3D point cloud data to obtain actual measured deformation data, comprising the following steps:
S310: generating real-time 3D point cloud data and transmitting to a local computing unit;
S320: dividing the real-time 3D point cloud data into gridded sub-regions, acquiring voxel points within each sub-region, denoising on voxel points within each sub-region;
S330: calculating, based on feature comparison between denoised real-time 3D point cloud data of each sub-regions and historical 3D point cloud data, a correlation degree between the denoised real-time 3D point cloud data and the historical 3D point cloud data, predefining a correlation degree threshold;
S340: identifying, when the correlation degree falls within the correlation degree threshold, the current real-time 3D point cloud data as duplicate data, and removing the duplicate data; and
S350: deriving, based on the de-duplicated real-time 3D point cloud data, actual measured deformation data.

In some implementations, in S330, calculating the correlation degree between real-time 3D point cloud data and historical 3D point cloud data using the following formula:

$$relevancy = \frac{1}{N} {\sum }_{n = 1}^{N} ( \vert \frac{{P}_{n}^{1} \cdot {P}_{n}^{2}}{‖ {P}_{n}^{1} ‖ ‖ {P}_{n}^{2} ‖} \vert \times \vert \frac{Δ {C}_{n}^{1} \cdot Δ {C}_{n}^{2}}{‖ Δ {C}_{n}^{1} ‖ ‖ Δ {C}_{n}^{2} ‖} \vert )$$

relevancy denotes the correlation degree, N represents a total number of sub-regions,

$${P}_{n}^{1}$$

corresponds to a geometric feature vector of a n-th sub-region in the real-time 3D point cloud data,

$${P}_{n}^{2}$$

denotes a geometric feature vector of a n-th sub-region in the historical 3D point cloud data,

$$Δ {C}_{n}^{1}$$

represents a relative displacement vector of a n-th sub-region in the real-time 3D point cloud data, and

$$Δ {C}_{n}^{2}$$

indicates a relative displacement vector of a n-th sub-region in the historical 3D point cloud data.

In some implementations, in S400, inverting, by employing the iterative optimization method based on comparison between structurally deformed results and measured deformation data, the time-varying performance parameters that most closely match actual conditions.

In some implementations, in S400, accumulating and storing, in the system database, the inverted time-varying performance parameters, iteratively proposing and refining, based on data analysis and model optimization, a new time-varying constitutive model.

In some implementations, achieving, based on large-scale data accumulation and analysis, the inversion analysis to support future 3D printing task optimization and material design.

In some implementations, achieving, based on large-scale data accumulation and analysis, the model optimization to support future 3D printing task optimization and material design Beneficial Effects:
1. The present disclosure enables accurate in-situ measurement of time-varying performance parameters of concrete materials during printing through integration of real-time monitoring and computational analysis. This approach transcends the constraints of laboratory conditions and reflects dynamic changes of the performance parameters of concrete materials under actual construction environments.
2. The present disclosure is applicable to 3D-printed concrete technologies in diverse complex construction environments, particularly in extreme conditions such as high temperature and humidity, providing precise material parameter determination to meet varied engineering requirements.
3. The present disclosure enhances inversion analysis efficiency by eliminating redundant 3D point cloud data through correlation analysis between real-time and historical 3D point cloud datasets, thereby reducing computational redundancy.

### BRIEF DESCRIPTION OF THE DRAWINGS

FIG. 1 is a schematic flowchart of a preferred embodiment of the present disclosure.

FIG. 2 is a schematic flowchart detailing the denoising and de-duplication process for 3D point cloud data in a preferred embodiment of the present disclosure.

### DETAILED DESCRIPTION

The following is a detailed explanation of the embodiments of the present disclosure. The embodiments are implemented under the premise of the technical solution of the present disclosure, wherein detailed implementation methods and specific operational procedures are provided. However, the protection scope of the present disclosure shall not be limited to the following embodiments.

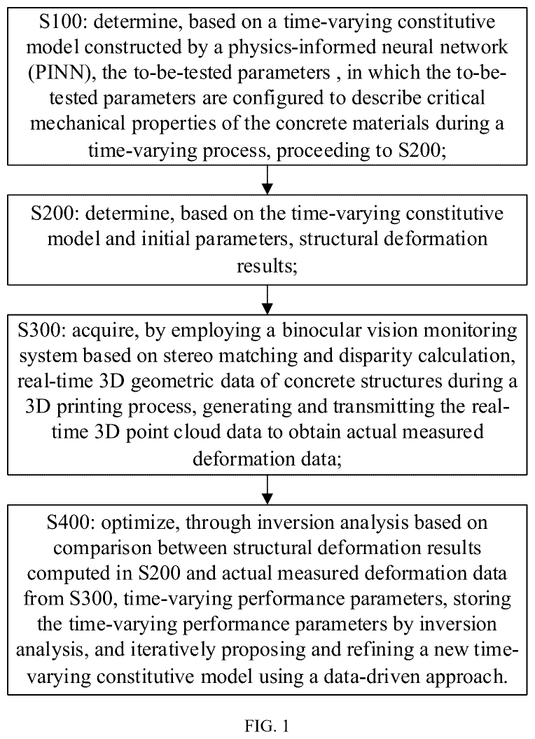

The present disclosure devises an in-situ measurement method for time-varying performance parameters of 3D-printed concrete materials. The technical solution includes the following steps, as shown in FIG. 1, specifically including:
S100: determining, based on a time-varying constitutive model constructed by a physics-informed neural network (PINN), the to-be-tested parameters, in which the to-be-tested parameters are configured to describe critical mechanical properties of the concrete materials during a time-varying process, proceeding to S200;
S200: determining, based on the time-varying constitutive model and initial parameters, structural deformation results;
S300: acquiring, by employing a binocular vision monitoring system based on stereo matching and disparity calculation, real-time 3D geometric data of concrete structures during a 3D printing process, generating and transmitting the real-time 3D point cloud data to obtain actual measured deformation data;
S400: optimizing, through inversion analysis based on comparison between structural deformation results computed in S200 and actual measured deformation data from S300, time-varying performance parameters, storing the time-varying performance parameters by inversion analysis, and iteratively proposing and refining a new time-varying constitutive model using a data-driven approach.

In some implementations, in S100, the to-be-tested parameters comprise but are not limited to the elastic modulus, viscosity coefficient, and strength parameter.

In some implementations, in S200, calculating, based on the predefined constitutive model and the initial parameters, corresponding structural deformation patterns for the inversion analysis.

In some implementations, in S300, generating, by employing 3D geometric data acquired from the binocular vision monitoring system based on stereo matching and disparity calculation, high-precision real-time 3D point cloud data, enabling a real-time update of material deformation information during the printing process.

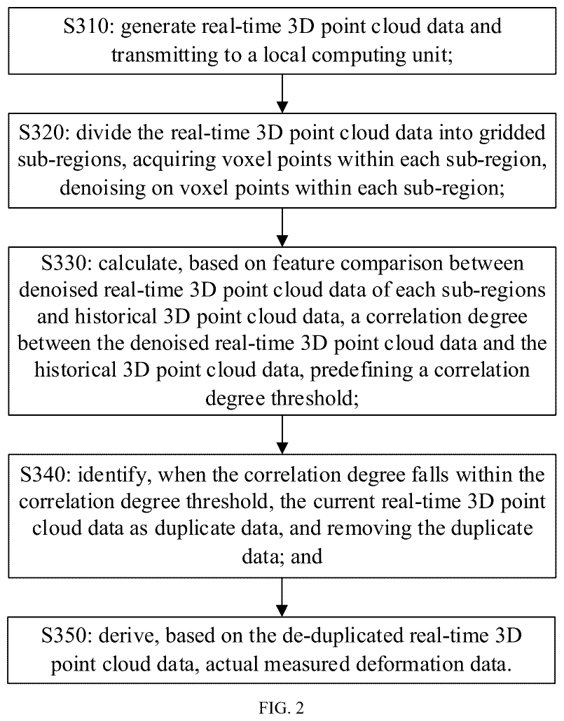

In some implementations, in S300, the generating and transmitting real-time 3D point cloud data to obtain actual measured deformation data, as shown in FIG. 2, comprising the following steps:
S310: generating real-time 3D point cloud data and transmitting to a local computing unit;
S320: dividing the real-time 3D point cloud data into gridded sub-regions, acquiring voxel points within each sub-region, denoising on voxel points within each sub-region;
S330: calculating, based on feature comparison between denoised real-time 3D point cloud data of each sub-regions and historical 3D point cloud data, a correlation degree between the denoised real-time 3D point cloud data and the historical 3D point cloud data, predefining a correlation degree threshold;
S340: identifying, when the correlation degree falls within the correlation degree threshold, the current real-time 3D point cloud data as duplicate data, and removing the duplicate data; and
S350: deriving, based on the de-duplicated real-time 3D point cloud data, actual measured deformation data.

Specifically, in S320, denoising is performed on voxel points within each sub-region using the following formula:

$${H}_{a} = ε \frac{{\sum }_{b ∈ A ( a )} exp ( - \frac{{( {h}_{a} - {h}_{b} )}^{2}}{2 {α}^{2}} ) exp ( - \frac{{l}_{a , b}^{2}}{2 {β}^{2}} ) {h}_{b}}{{\sum }_{b ∈ A ( a )} exp ( - \frac{{( {h}_{a} - {h}_{b} )}^{2}}{2 {α}^{2}} ) exp ( - \frac{{l}_{a , b}^{2}}{2 {β}^{2}} )} + ( 1 - ε ) \frac{{\sum }_{b ∈ A ( a )} {S}_{a , b} {h}_{b}}{{\sum }_{b ∈ A ( a )} {S}_{a , b}}$$

In the formula, Hₐ denotes the denoised gray scale value of voxel point a; hₐ represents the original gray scale value of voxel point a; h_{b} corresponds to the original gray scale value of voxel point b; ε signifies the denoising filter weight; α denotes the standard deviation of gray scale differences for the Gaussian kernel; β corresponds to the standard deviation of spatial distances for the Gaussian kernel; l_{a, b} represents the Euclidean distance between voxel points a and b; S_{a, b} indicates the similarity weight between voxel points a and b; and A(a) denotes the set of voxel points within the sub-region associated with voxel point a.

In some implementations, S_{a, b} denotes the similarity weight between voxel points a and b, which is given by the following formula:

$${S}_{a , b} = exp ( - \frac{{‖ {n}_{a} - {n}_{b} ‖}^{2}}{{γ}^{2}} )$$

In the formula, nₐ denotes the normal vector of voxel point a; ng denotes the normal vector of voxel point b; γ² represents the adjustment parameter.

In the process, the denoising of voxel points within each sub-region incorporates two filtering strategies. A weighted hybrid output is employed to denoise the voxel points in the sub-regions, where bilateral filtering removes Gaussian noise while similarity filtering preserves structural features to avoid excessive smoothing. This hybrid approach effectively addresses mixed noise (e.g., Gaussian noise+structural noise), outperforming single-filter methods. The gridded sub-regions constrain the neighborhood search range A(a), reducing computational complexity and enabling adaptation to real-time processing demands. By retaining critical geometric features of concrete structures (e.g., interlayer joints and surface texture), noise is effectively removed to ensure the precision of subsequent deformation analysis.

In some implementations, in S330, calculating the correlation degree between real-time 3D point cloud data and historical 3D point cloud data using the following formula:

$$relevancy = \frac{1}{N} {\sum }_{n = 1}^{N} ( \vert \frac{{P}_{n}^{1} \cdot {P}_{n}^{2}}{‖ {P}_{n}^{1} ‖ ‖ {P}_{n}^{2} ‖} \vert \times \vert \frac{Δ {C}_{n}^{1} \cdot Δ {C}_{n}^{2}}{‖ Δ {C}_{n}^{1} ‖ ‖ Δ {C}_{n}^{2} ‖} \vert )$$

relevancy denotes the correlation degree, N represents a total number of sub-regions,

$${P}_{n}^{1}$$

corresponds to a geometric feature vector of a n-th sub-region in the real-time 3D point cloud data,

$${P}_{n}^{2}$$

denotes a geometric feature vector of a n-th sub-region in the historical 3D point cloud data,

$$Δ {C}_{n}^{1}$$

represents a relative displacement vector of a n-th sub-region in the real-time 3D point cloud data, and

$$Δ {C}_{n}^{2}$$

indicates a relative displacement vector of a n-th sub-region in the historical 3D point cloud data.

Specifically, the present disclosure determines duplicate data through correlation threshold judgment to reduce redundant computations and enhance inversion analysis efficiency. Herein, the geometric feature vectors of sub-regions include but are not limited to normal vectors, principal component directions, and curvature, reflecting the shape features of sub-regions. Displacement vectors, on the other hand, reflect the overall positional changes of sub-regions, such as translation and settlement. By introducing both geometric feature vectors and displacement vectors, the method covers additional deformation models. For example, relying solely on geometric features may fail to detect deformations where “the overall position shifts but the shape remains unchanged,” while relying solely on displacement vectors may overlook “local deformations occurring under unchanged positions.”

Furthermore,

$$Δ {C}_{n}^{1}$$

denotes the relative displacement vector of the n-th sub-region in real-time 3D point cloud data, and

$$Δ {C}_{n}^{2}$$

represents the relative displacement vector of the n-th sub-region in historical 3D point cloud data (i.e., providing reference points

$${C}_{n}^{3} ) .$$

The relative displacement vectors are solved by real-time data and historical data, as follows:

$$\begin{matrix}Δ {C}_{n}^{1} = {C}_{n}^{1} - {C}_{n}^{3} \\ Δ {C}_{n}^{2} = {C}_{n}^{2} - {C}_{{n}^{o}}^{3}\end{matrix}$$

Additionally, regarding the selection of the correlation threshold, the present disclosure adaptively optimizes the threshold based on real-time data. This includes maintaining a fixed-length window where data within the window is time-weighted (with higher weights assigned to recent data), dynamically calculating the mean and standard deviation of correlation values within the window to update the threshold.

In some implementations, in S400, inverting, by employing the iterative optimization method based on comparison between structurally deformed results and measured deformation data, the time-varying performance parameters that most closely match actual conditions.

In some implementations, in S400, accumulating and storing, in the system database, the inverted time-varying performance parameters, iteratively proposing and refining, based on data analysis and model optimization, a new time-varying constitutive model.

In some implementations, achieving, based on large-scale data accumulation and analysis, the inversion analysis to support future 3D printing task optimization and material design. In some implementations, achieving, based on large-scale data accumulation and analysis, the model optimization to support future 3D printing task optimization and material design

Specifically, the technical devices and methods involved in the present disclosure include:

### (1) Constructing a Physics-Informed Neural Network (PINN) Constitutive Model:

A PINN is established to describe the time-varying behavior of 3D-printed concrete materials by integrating mechanical equations, material constitutive relationships, and control equations. The network is trained employing a combination of supervised and unsupervised learning methods to accurately characterize the time-varying mechanical properties of concrete.

### (2) Binocular Vision Monitoring System:

The binocular vision monitoring system employed in the present disclosure is configured to real-time capture and record the three-dimensional geometric morphology of each layer of concrete during the 3D printing process. The system employs stereo matching and disparity calculation technologies to generate high-precision 3D point cloud data, thereby ensuring precise recording of the geometric morphology during the printing process. These point cloud data are subsequently used for parameter inversion analysis to monitor and evaluate material performance changes in real time.

### (3) Parameter Inversion Analysis Method:

The parameter inversion analysis method determines the time-varying performance parameters most consistent with the actual conditions by comparing actual measured 3D point cloud data with computational analysis results. The method includes the following steps:
a. Data matching and error analysis: actual measured data are matched with computational analysis results and discrepancies are analyzed between them.
b. Iterative optimization: to-be-tested parameters are adjusted based on error analysis results. Parameter settings are refined iteratively by repeated simulations until simulation outcomes closely align with actual data.
c. Result validation: Verified parameters acquired by the final inversion analysis are adopted as reliable references for subsequent structural design and analysis.

The above detailed description illustrates preferred embodiments of the present disclosure. It should be understood that numerous modifications and variations can be made to the present disclosure by those skilled in the art without requiring creative effort, based on the disclosed concepts and principles of the present disclosure. Therefore, any technical solution derivable from the inventive concept through logical analysis, reasoning, or limited experimentation by those skilled in the art shall fall within the protection scope defined by the claims.

1. A method for in-situ determination of time-varying performance parameters of 3d-printed concrete materials, comprising following steps:
S100: determining, based on a time-varying constitutive model constructed by a physics-informed neural network (PINN), the to-be-tested parameters, in which the to-be-tested parameters are configured to describe critical mechanical properties of the concrete materials during a time-varying process, proceeding to S200;
S200: determining, based on the time-varying constitutive model and initial parameters, structural deformation results;
S300: acquiring, by employing a binocular vision monitoring system based on stereo matching and disparity calculation, real-time 3D geometric data of concrete structures during a 3D printing process, generating and transmitting the real-time 3D point cloud data to obtain actual measured deformation data; and
S400: optimizing, through inversion analysis based on comparison between structural deformation results computed in S200 and actual measured deformation data from S300, time-varying performance parameters, storing the time-varying performance parameters by inversion analysis, and iteratively proposing and refining a new time-varying constitutive model using a data-driven approach.

2. The method for in-situ determination of time-varying performance parameters of 3d-printed concrete materials according to claim 1, wherein, in S100, the to-be-tested parameters comprise but are not limited to the elastic modulus, viscosity coefficient, and strength parameter.

3. The method for in-situ determination of time-varying performance parameters of 3d-printed concrete materials according to claim 1, wherein, in S200, calculating, based on the predefined constitutive model and the initial parameters, corresponding structural deformation patterns for the inversion analysis.

4. The method for in-situ determination of time-varying performance parameters of 3d-printed concrete materials according to claim 1, wherein, in S300, generating, by employing 3D geometric data acquired from the binocular vision monitoring system based on stereo matching and disparity calculation, high-precision real-time 3D point cloud data, enabling a real-time update of material deformation information during the printing process.

5. The method for in-situ determination of time-varying performance parameters of 3d-printed concrete materials according to claim 1, wherein, in S300, the generating and transmitting real-time 3D point cloud data to obtain actual measured deformation data, comprising the following steps:
S310: generating real-time 3D point cloud data and transmitting to a local computing unit;
S320: dividing the real-time 3D point cloud data into gridded sub-regions, acquiring voxel points within each sub-region, denoising on voxel points within each sub-region;
S330: calculating, based on feature comparison between denoised real-time 3D point cloud data of each sub-regions and historical 3D point cloud data, a correlation degree between the denoised real-time 3D point cloud data and the historical 3D point cloud data, predefining a correlation degree threshold;
S340: identifying, when the correlation degree falls within the correlation degree threshold, the current real-time 3D point cloud data as duplicate data, and removing the duplicate data; and
S350: deriving, based on the de-duplicated real-time 3D point cloud data, actual measured deformation data.

6. The method for in-situ determination of time-varying performance parameters of 3d-printed concrete materials according to claim 5, wherein, in S330, calculating the correlation degree between real-time 3D point cloud data and historical 3D point cloud data using the following formula:
$$relevancy = \frac{1}{N} {\sum }_{n = 1}^{N} ( \vert \frac{{P}_{n}^{1} \cdot {P}_{n}^{2}}{‖ {P}_{n}^{1} ‖ ‖ {P}_{n}^{2} ‖} \vert \times \vert \frac{Δ {C}_{n}^{1} \cdot Δ {C}_{n}^{2}}{‖ Δ {C}_{n}^{1} ‖ ‖ Δ {C}_{n}^{2} ‖} \vert )$$
relevancy denotes the correlation degree, N represents a total number of sub-regions,
$${P}_{n}^{1}$$
corresponds to a geometric feature vector of a n-th sub-region in the real-time 3D point cloud data,
$${P}_{n}^{2}$$
denotes a geometric feature vector of a n-th sub-region in the historical 3D point cloud data,
$$Δ {C}_{n}^{1}$$
represents a relative displacement vector of a n-th sub-region in the real-time 3D point cloud data, and
$$Δ {C}_{n}^{2}$$
indicates a relative displacement vector of a n-th sub-region in the historical 3D point cloud data.

7. The method for in-situ determination of time-varying performance parameters of 3d-printed concrete materials according to claim 1, wherein, in S400, inverting, by employing the iterative optimization method based on comparison between structurally deformed results and measured deformation data, the time-varying performance parameters that most closely match actual conditions.

8. The method for in-situ determination of time-varying performance parameters of 3d-printed concrete materials according to claim 1, wherein, in S400, accumulating and storing, in the system database, the inverted time-varying performance parameters, iteratively proposing and refining, based on data analysis and model optimization, a new time-varying constitutive model.

9. The method for in-situ determination of time-varying performance parameters of 3d-printed concrete materials according to claim 1, wherein, achieving, based on large-scale data accumulation and analysis, the inversion analysis to support future 3D printing task optimization and material design.

10. The method for in-situ determination of time-varying performance parameters of 3d-printed concrete materials according to claim 1, wherein, achieving, based on large-scale data accumulation and analysis, the model optimization to support future 3D printing task optimization and material design
